(19) United States
(12) Patent Application Publication
(10) Pub. No.: US 2025/0191603 A1
(43) Pub. Date: Jun. 12, 2025

(54) SYSTEMS AND METHODS FOR REDUCING ECHO USING SPEECH DECOMPOSITION

(71) Applicant: QUALCOMM Incorporated, San Diego, CA (US)

(72) Inventors: Shuhua ZHANG, San Diego, CA (US); Erik VISSER, San Diego, CA (US); Jason FILOS, San Diego, CA (US); Siddhartha Goutham SWAMINATHAN, San Diego, CA (US)

(21) Appl. No.: 18/846,309

(22) PCT Filed: Feb. 24, 2023
(86) PCT No.: PCT/US23/63234

§ 371 Date: Sep. 12, 2024

(30) Foreign Application Priority Data
Apr. 27, 2022 (GR) 20220100350

(51) Int. Cl. G10L 21/0232; G10L 21/0272; G10L 25/30

(52) U.S. Cl. CPC G10L 21/0232; G10L 21/0272; G10L 25/30

(57) ABSTRACT

A method includes performing, at a first neural network, a first decomposition operation on a transformed input speech signal to generate a voiced component of the transformed input speech signal. The transformed input speech signal includes frequency-domain transformed near-end speech components stacked with frequency-domain transformed far-end speech components. The method also includes performing, at a second neural network, a second decomposition operation on the transformed input speech signal to generate an unvoiced component of the transformed input speech signal. The first neural network and the second neural network perform echo cancellation on the transformed input speech signal. The method further includes merging, at a third neural network, the voiced component and the unvoiced component to generate a transformed output speech signal.

### CROSS-REFERENCE TO RELATED APPLICATIONS

The present application claims the benefit of priority from the commonly owned Greece Provisional Patent Application No. 20220100350, filed Apr. 27, 2022, the contents of which are expressly incorporated herein by reference in their entirety.

### FIELD

The present disclosure is generally related to echo cancellation.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice packets, data packets, or both, over wired or wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

One common use of a wireless device is voice communications. As a non-limiting example, during a phone call, a first user of the wireless device can speak into a microphone of the wireless device to communicate with a second user. However, when the first user speaks into the microphone, in some scenarios, the user speech can be subject to echoes. For example, the microphone can inadvertently capture speech from the second user when the speech from the second user is output to the first user via a speaker of the wireless device. Thus, by capturing the speech from the second user, an inadvertent echo can be created.

Typically, a single architecture or module is used to process user speech for echo cancellation. As a non-limiting example, a monolithic network can process speech having both voiced components and unvoiced components to cancel echo characteristics and suppress noise. However, because voiced components and unvoiced components have drastically different probability distributions, using a monolithic network can be inefficient and can reduce the speech quality of resulting output speech. For example, by applying the same weights and coefficients to process the voiced and unvoiced components in the monolithic network, the speech quality of at least one of the components can be compromised.

### SUMMARY

According to a particular aspect, a device includes a first neural network configured to perform a first decomposition operation on a transformed input speech signal to generate a voiced component of the transformed input speech signal. The transformed input speech signal includes frequency-domain transformed near-end speech components stacked with frequency-domain transformed far-end speech components. The device also includes a second neural network configured to perform a second decomposition operation on the transformed input speech signal to generate an unvoiced component of the transformed input speech signal. The first neural network and the second neural network perform echo cancellation on the transformed input speech signal. The device further includes a third neural network configured to merge the voiced component and the unvoiced component to generate a transformed output speech signal.

According to another particular aspect, a method includes performing, at a first neural network, a first decomposition operation on a transformed input speech signal to generate a voiced component of the transformed input speech signal. The transformed input speech signal includes frequency-domain transformed near-end speech components stacked with frequency-domain transformed far-end speech components. The method also includes performing, at a second neural network, a second decomposition operation on the transformed input speech signal to generate an unvoiced component of the transformed input speech signal. The first neural network and the second neural network perform echo cancellation on the transformed input speech signal. The method further includes merging, at a third neural network, the voiced component and the unvoiced component to generate a transformed output speech signal.

According to another particular aspect, a non-transitory computer-readable medium includes instructions that, when executed by one or more processors, cause the one or more processors to perform, at a first neural network, a first decomposition operation on a transformed input speech signal to generate a voiced component of the transformed input speech signal. The transformed input speech signal includes frequency-domain transformed near-end speech components stacked with frequency-domain transformed far-end speech components. The instructions also cause the one or more processors to perform, at a second neural network, a second decomposition operation on the transformed input speech signal to generate an unvoiced component of the transformed input speech signal. The first neural network and the second neural network perform echo cancellation on the transformed input speech signal. The instructions further cause the one or more processors to merge, at a third neural network, the voiced component and the unvoiced component to generate a transformed output speech signal.

According to another particular aspect, an apparatus includes means for performing a first decomposition operation on a transformed input speech signal to generate a voiced component of the transformed input speech signal. The transformed input speech signal includes frequency-domain transformed near-end speech components stacked with frequency-domain transformed far-end speech components. The apparatus also includes means for performing a second decomposition operation on the transformed input speech signal to generate an unvoiced component of the transformed input speech signal. The means for performing the first decomposition operation and the means for performing the second decomposition operation perform echo cancellation on the transformed input speech signal. The apparatus further includes means for merging the voiced component and the unvoiced component to generate a transformed output speech signal.

### BRIEF DESCRIPTION OF THE DRAWINGS

FIG. 1 is a diagram of a particular illustrative example of a system that is configured to reduce echoes associated with input speech using a voiced neural network and an unvoiced neural network.

FIG. 2 is a diagram of a particular illustrative example of a system that is configured to reduce echoes associated with input speech using a voiced neural network and an unvoiced neural network.

FIG. 3 is a diagram of a particular illustrative example of performing a decomposition operation on stacked and transformed near-end speech and far-end speech using a convolutional u-net architecture.

FIG. 4 is a diagram of a particular illustrative example of performing a decomposition operation on stacked and transformed near-end speech and far-end speech using a recurrent u-net architecture.

FIG. 5 is a diagram of a particular illustrative example of performing a decomposition operation on stacked and transformed near-end speech and far-end speech using a recurrent layer architecture.

FIG. 6 is a block diagram illustrating an implementation of an integrated circuit that is configured to reduce echoes associated with input speech using a voiced neural network and an unvoiced neural network.

FIG. 7 depicts an implementation of a mobile device that is configured to reduce echoes associated with input speech using a voiced neural network and an unvoiced neural network.

FIG. 8 depicts an implementation of a portable electronic device that is configured to reduce echoes associated with input speech using a voiced neural network and an unvoiced neural network.

FIG. 9 depicts an implementation of a wearable electronic device that is configured to reduce echoes associated with input speech using a voiced neural network and an unvoiced neural network.

FIG. 10 is an implementation of a wireless speaker and voice activated device that is configured to reduce echoes associated with input speech using a voiced neural network and an unvoiced neural network.

FIG. 11 depicts an implementation of a headset device that is configured to reduce echoes associated with input speech using a voiced neural network and an unvoiced neural network.

FIG. 12 depicts an implementation in which a vehicle is configured to reduce echoes associated with input speech using a voiced neural network and an unvoiced neural network.

FIG. 13 depicts another implementation of a vehicle that is configured to reduce echoes associated with input speech using a voiced neural network and an unvoiced neural network.

FIG. 14 is a flowchart of a particular example of a method of reducing echoes associated with input speech using a voiced neural network and an unvoiced neural network.

FIG. 15 is a diagram of a particular example of components of a device that is configured to reduce echoes associated with input speech using a voiced neural network and an unvoiced neural network.

FIG. 16 is a block diagram of a particular illustrative example of a device that is operable to reduce echoes associated with input speech using a voiced neural network and an unvoiced neural network.

### DETAILED DESCRIPTION

An electronic device (e.g., a mobile device, a headset, etc.) can include at least one microphone configured to capture first user speech from a first user. Typically, the first user's mouth is proximate to (e.g., near) the microphone. However, in addition the capturing first user speech from the first user, the microphone can also capture noise in a surrounding environment of the first user. The first user speech (and surrounding environmental noise) captured by the microphone can be classified as “near-end speech.” In some circumstances, the microphone can also capture second user speech output by a speaker associated with the electronic device. As a non-limiting example, if the first user and a second user are participating in a voice call, in addition to capturing the near-end speech, the microphone can also capture the second user speech from the second user output by the speaker. The second user speech (and any surrounding noise) output by the speaker can be classified as “far-end speech.” The microphone can generate a near-end speech signal based on the captured near-end speech. However, as described above, because the microphone can inadvertently capture far-end speech output by the speaker, the near-end speech signal generated by the microphone can include captured far-end speech components.

The techniques described herein utilize a combination of trained neural networks to reduce (or cancel out) echo associated with the near-end speech signal, in particular the echo associated with the inadvertently captured far-end speech components. For example, if far-end speech (e.g., speech from the second user) is captured and transmitted back to the second user, the second user can hear an echo. To reduce the echo, the near-end speech signal can be provided to an echo-cancellation system that includes a first transform unit, a second transform unit, a combining unit, a first neural network (e.g., a voiced network), a second neural network (e.g., an unvoiced network), and a third neural network (e.g., a merge network). The first transform unit can be configured to perform a transform operation on the near-end speech signal to generate a transformed near-end speech signal (e.g., a frequency-domain version of the near-end speech signal). Thus, the transformed near-end speech signal corresponds to a transformed version of the near-end speech and can also include a residual transformed version of the far-end speech (based on the far-end speech inadvertently captured by microphone).

Additionally, a far-end audio signal indicative of the far-end speech from the speaker can be transformed by the second transform unit to generate a transformed far-end speech signal. The transformed far-end speech signal and the transformed near-end speech signal are provided to the combining unit, and the combining unit can be configured to generate a transformed input speech signal based on the transformed far-end speech signal and the transformed near-end speech signal. For example, the transformed input speech signal can include frequency-domain transformed near-end speech components (based on the transformed near-end speech signal) stacked with frequency-domain transformed far-end speech components (based on the transformed far-end speech signal).

The transformed input speech signal is provided to the first neural network and to the second neural network. The first neural network can perform a first decomposition operation on the transformed input speech signal to generate a voiced component. For example, the first neural network can apply a voice mask or identify transform coefficients (e.g., Fast Fourier Transform (FFT) coefficients) to isolate and extract voiced components from the transformed input speech signal. In some implementations, after extracting the voiced component, the first neural network can process the voiced component to improve gain, reduce noise, reduce echo, etc. The second neural network can perform a second decomposition operation on the transformed input speech signal to generate an unvoiced component. For example, the second neural network can apply an unvoiced mask or identify transform coefficients (e.g., FFT coefficients) to isolate and extract the unvoiced components from the transformed microphone signal. In some implementations, after extracting the unvoiced components, the second neural network can process the unvoiced components to reduce gain, reduce noise, reduce echo, etc. Typically, a large part of the echo can be contributed to the unvoiced component. Thus, to reduce echo, the second neural network can significantly reduce the gain of the unvoiced component to reduce the echo. The third neural network can merge the processed voiced component and the processed unvoiced component to generate a transformed output speech signal (e.g., an echo-cancelled signal indicative of clean speech) with a reduced amount of noise and echo.

Thus, the techniques described herein improve the quality of speech decomposition and reconstruction by using multiple neural networks to process different components of the transformed input speech signal. For example, voiced components can be processed using a first neural network and unvoiced components can be processed using a second neural network. As a result, a single neural network does not have to process different speech parts (e.g., voiced and unvoiced parts) with drastically different probability distributions, which enables improved speech quality and weight efficiency.

Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from another component, block, or device), and/or retrieving (e.g., from a memory register or an array of storage elements).

Unless expressly limited by its context, the term “producing” is used to indicate any of its ordinary meanings, such as calculating, generating, and/or providing. Unless expressly limited by its context, the term “providing” is used to indicate any of its ordinary meanings, such as calculating, generating, and/or producing. Unless expressly limited by its context, the term “coupled” is used to indicate a direct or indirect electrical or physical connection. If the connection is indirect, there may be other blocks or components between the structures being “coupled.” For example, a loudspeaker may be acoustically coupled to a nearby wall via an intervening medium (e.g., air) that enables propagation of waves (e.g., sound) from the loudspeaker to the wall (or vice-versa).

The term “configuration” may be used in reference to a method, apparatus, device, system, or any combination thereof, as indicated by its particular context. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). In the case (i) where A is based on B includes based on at least, this may include the configuration where A is coupled to B. Similarly, the term “in response to” is used to indicate any of its ordinary meanings, including “in response to at least.” The term “at least one” is used to indicate any of its ordinary meanings, including “one or more.” The term “at least two” is used to indicate any of its ordinary meanings, including “two or more.”

The terms “apparatus” and “device” are used generically and interchangeably unless otherwise indicated by the particular context. Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The terms “method,” “process,” “procedure,” and “technique” are used generically and interchangeably unless otherwise indicated by the particular context. The terms “element” and “module” may be used to indicate a portion of a greater configuration. The term “packet” may correspond to a unit of data that includes a header portion and a payload portion. Any incorporation by reference of a portion of a document shall also be understood to incorporate definitions of terms or variables that are referenced within the portion, where such definitions appear elsewhere in the document, as well as any figures referenced in the incorporated portion.

As used herein, the term “communication device” refers to an electronic device that may be used for voice and/or data communication over a wireless communication network. Examples of communication devices include speaker bars, smart speakers, cellular phones, personal digital assistants (PDAs), handheld devices, headsets, wireless modems, laptop computers, personal computers, etc.

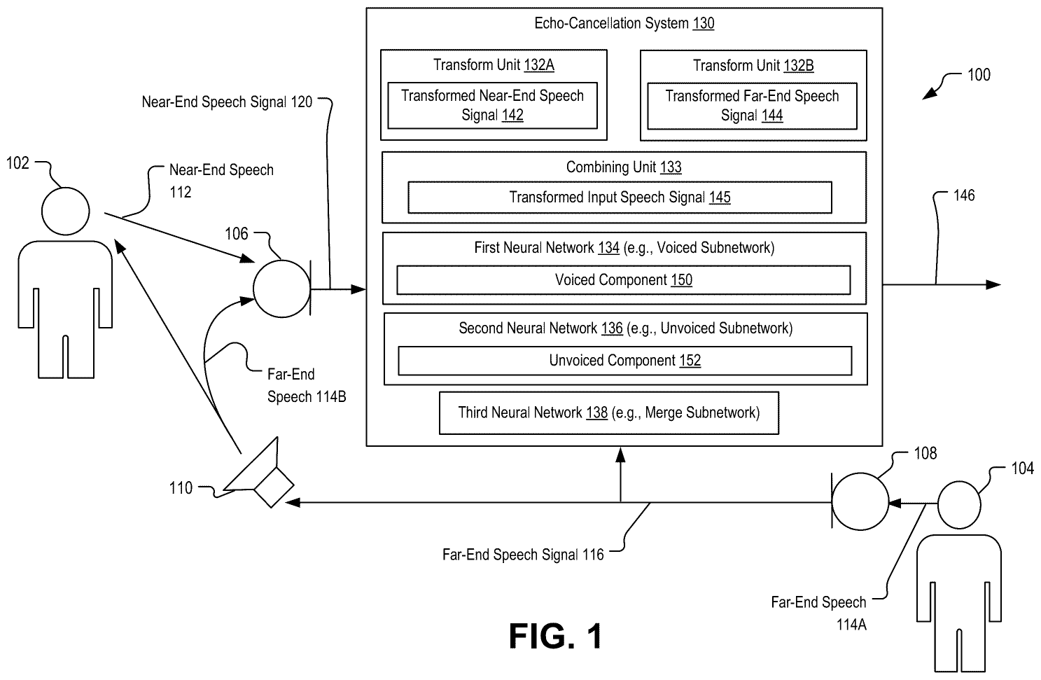

Particular aspects are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple transform units are illustrated and associated with reference numbers 132A and 132B. When referring to a particular one of these transform units, such as the transform unit 132A, the distinguishing letter “A” is used. However, when referring to any arbitrary one of these transform units or to these transform units as a group, the reference number 132 is used without a distinguishing letter.

FIG. 1 is a diagram of a particular illustrative example of a system 100 that is configured to reduce echoes associated with user speech using a voiced neural network and an unvoiced neural network. For example, the system 100 can employ a first trained neural network architecture (e.g., a first neural network 134) to isolate and process voiced components of the user speech. The system 100 can also employ a second trained neural network architecture (e.g., a second neural network 136) to isolate and process unvoiced components of the user speech. As described below, the outputs of the two neural network architectures can be merged to create a version of the user speech that has a reduced amount of echo.

In FIG. 1, a first user 102 is proximate to a first microphone 106 and speaker 110. In some implementations, the first microphone 106 and the speaker 110 can be integrated into a first device, such as a first mobile phone or a first headset. Speech from the first user 102 can be captured by the first microphone 106. Additionally, noise in a surrounding environment of the first user 102 can be captured by the first microphone 106. In FIG. 1, the speech from the first user 102 (and the noise from the surrounding environment) that is captured by the first microphone 106 is characterized as near-end speech 112.

Additionally, in FIG. 1, a second user 104 is proximate to a second microphone 108. In some implementations, the second microphone 108 can be integrated into a second device, such as a second mobile phone or a second headset. Speech from the second user 104 can be captured by the second microphone 108. Additionally, noise in a surrounding environment of the second user 104 can be captured by the second microphone 108. As described below, from the perspective of the first user 102 (or the first microphone 106), the speech from the second user 104 (and the noise from the surrounding environment) that is captured by the second microphone 108 is characterized as far-end speech 114A.

According to an implementation, the first user 102 and the second user 104 can be participating in a communication, such as a voice call or a video call. During the communication, in addition to capturing the near-end speech 112, the first microphone 106 can inadvertently capture far-end speech 114B originating from the second user 104. For example, the second microphone 108 can capture the far-end speech 114A and generate a far-end speech signal 116 indicative of the far-end speech 114A. The far-end speech signal 116 can be provided to the speaker 110, and the speaker 110 can output the far-end speech 114B. The far-end speech 114B can be substantially similar to the far-end speech 114A; however, property changes or distortions can occur during processing of the far-end speech signal 116 that results in some difference between the far-end speech 114B as output by the speaker 110 and the far-end speech 114A as spoken by the second user 104. As an example, the far-end speech signal 116 can undergo additional processing at the device associated with the first user 102, the device associated with the second user 104, or both, that can cause subtle property changes or distortions.

Because the far-end speech 114B is output by the speaker 110, in addition to the user 102 hearing the far-end speech 114B, the far-end speech 114B can inadvertently be captured by the first microphone 106. Thus, the first microphone 106 can capture the near-end speech 112 and the far-end speech 114B, which may exhibit further changes, such as attenuation, delay, reflections, etc., associated with propagation of the far-end speech 114B from the speaker 110 to the first microphone 106. In response to capturing the near-end speech 112 (and inadvertently capturing portions of the far-end speech 114B), the first microphone 106 can be configured to generate a near-end speech signal 120.

One drawback of capturing the far-end speech 114B is the creation of an echo, such as double-talk. For example, if the first microphone 106 captures the far-end speech 114B (e.g., speech from the second user 104) in addition to the near-end speech 112, during the communication, the far-end speech 114B can be transmitted back to the second user 104 in the form of an echo. Since both the speech of the first user 102 and the speech of second user 104 are more similar to each other than to environmental noise, removing of the speech of the second user 104 from the speech of the first user 102 in the output of the microphone 106 can be very difficult using conventional techniques such as adaptive linear filtering. In contrast, techniques described herein reduce the amount of echo that is transmitted using separate trained neural networks for voiced components and unvoiced components, and can cancel double-talk based on pitch differences between the speech of the users 102 and 104. In particular, the system 100 includes an echo-cancellation system 130 that uses separate trained neural networks for voiced and unvoiced components and that is operable to reduce or eliminate echo (e.g., double-talk) caused by the first microphone 106 capturing the far-end speech 114B.

To illustrate, the near-end speech signal 120 is provided to the echo-cancellation system 130. The echo-cancellation system 130 includes a transform unit 132A, a transform unit 132B, a combining unit 133, the first neural network 134, the second neural network 136, and the third neural network 138. The transform unit 132A can be configured to perform a transform operation on the near-end speech signal 120 to generate a transformed near-end speech signal 142. As described herein, a “transform operation” can correspond to a Fast Fourier Transform (FFT) operation, a Fourier Transform operation, a Discrete Cosine Transform (DCT) operation, or any other transform operation that transform a time-domain signal into a frequency-domain signal (as used herein, “frequency-domain” can refer to any such transform domain, including feature domains). Thus, the transform unit 132A can transform the near-end speech signal 120 from a time-domain signal to a frequency-domain signal. As a result, the transformed near-end speech signal 142 can include frequency-domain near-end speech components (e.g., frequency-domain representations of the near-end speech 112). The transformed near-end speech signal 142 is provided to the combining unit 133.

The far-end speech signal 116 can also be provided to the echo-cancellation system 130. The transform unit 132B can be configured to perform a transform operation on the far-end speech signal 116 to generate a transformed far-end speech signal 144. Thus, the transform unit 132B can transform the far-end speech signal 116 from a time-domain signal to a frequency-domain signal. As a result, the transformed far-end speech signal 144 can include frequency-domain far-end speech components (e.g., frequency-domain representations of the far-end speech 114A). The transformed far-end speech signal 144 is also provided to the combining unit 133.

The combining unit 133 can be configured to concatenate, interleave, or otherwise aggregate or combine the transformed near-end speech signal 142 and the transformed far-end speech signal 144 to generate a transformed input speech signal 145. The transformed input speech signal 145 can include frequency-domain transformed near-end speech components (based on the transformed near-end speech signal 142) stacked with frequency-domain transformed far-end speech components (based on the transformed far-end speech signal 144). The transformed input speech signal 145 is provided to the first neural network 134 and to the second neural network 136.

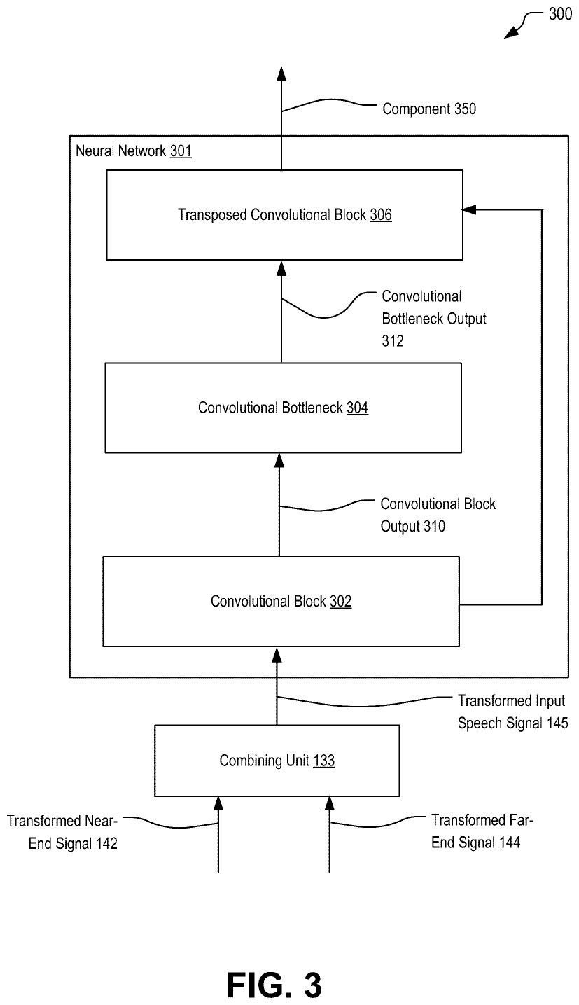

The first neural network 134 is configured to perform a first decomposition operation on the transformed input speech signal 145 to generate a voiced component 150 of the transformed input speech signal 145. For example, the first neural network 134 can correspond to a voiced subnetwork that is trained to apply a voice mask (or identify transform coefficients) to isolate and extract the voiced component 150 from the transformed input speech signal 145. Because the voiced component 150 is typically representative of near-end speech 112, the first neural network 134 can be trained to perform additional processing on the voiced component 150, such as increase the gain of the voiced component 150. The voiced component 150 is provided to the third neural network 138. As described with respect to FIGS. 3-5, the first neural network 134 can have one of a recurrent layer architecture, a convolutional u-net architecture, or a recurrent u-net architecture.

Based on using the transform coefficients of the transformed far-end speech signal 144 (e.g., the transform coefficients of the frequency-domain transformed far-end speech components) as a reference signal indicative of the far-end speech 114B captured by the microphone 106, the first neural network 134 can be trained to attenuate or eliminate components of the transformed input speech signal 145, in the voiced component 150, that correspond to the far-end speech 114B. Thus, the first neural network 134 can be trained to use this information to perform echo-cancellation for the voiced component 150. Although the first neural network 134 is described as performing various functions, such as voiced/unvoiced decomposition, applying gain, and performing echo-cancellation, it should be understood that the first neural network 134 may perform any or all of these functions as a single combined operation rather than as a sequence of discrete operations.

The second neural network 136 is configured to perform a second decomposition operation on the transformed input speech signal 145 to generate an unvoiced component 152 of the transformed input speech signal 145. For example, the second neural network 136 can correspond to an unvoiced subnetwork that is trained to apply an unvoiced mask (or identify transform coefficients) to isolate and extract the unvoiced component 152 from the transformed input speech signal 145. The second neural network 136 is also trained to use the transform coefficients of the transformed far-end speech signal 144, received in the transformed input speech signal 145, as a reference signal to attenuate or eliminate components of the transformed input speech signal 145, in the unvoiced component 152, that correspond to the far-end speech 114B. Because the unvoiced component 152 is typically representative of far-end speech 114B captured by the first microphone 106, the second neural network 136 can be trained to perform additional processing on the unvoiced component 152, such as decrease the gain of the unvoiced component 152. The unvoiced component 152 is provided to the third neural network 138. As described with respect to FIGS. 3-5, the second neural network 136 can have one of a recurrent layer architecture, a convolutional u-net architecture, or a recurrent u-net architecture.

The third neural network 138 is configured to merge the voiced component 150 and the unvoiced component 152 to generate a transformed output speech signal 146. According to an implementation, the third neural network 138 can apply an unconditional unweighted sum of voiced component 150 and the unvoiced component 152 to generate the transformed output speech signal 146. According to another implementation, the third neural network 138 can apply weights to the components 150, 152. As a non-limiting example, the third neural network 138 can apply a first set of weights to elements of the voiced component 150 and a second set of weights (distinct from the first set of weights) to the unvoiced component 152. In this example, the weighted components can be merged, such as a via an element-wise sum of corresponding weighted elements. The transformed output speech signal 146 can correspond to an echo-cancelled signal indicative of clean speech (e.g., a clean version of the near-end speech 112) with a reduced amount of noise and echo.

Thus, the techniques described herein improve the quality of speech decomposition and reconstruction by using multiple neural networks 134, 136 to process different respective components of the transformed input speech signal 145. For example, the voiced component 150 can be processed using the first neural network 134, and the unvoiced component 152 can be processed using the second neural network 136. As a result, a single neural network does not have to process different speech parts (e.g., voiced and unvoiced parts) having different statistics, which enables improved speech quality and weight efficiency. Additionally, compared to conventional techniques (e.g., adaptive linear filtering), the techniques described herein can reduce or eliminate echo (e.g., double-talk) caused by the first microphone 106 capturing the far-end speech 114B. For example, the techniques described herein reduce the amount of echo that is transmitted using separate trained neural networks for voiced components and unvoiced components, and can cancel double-talk based on pitch differences between the speech of the users 102 and 104.

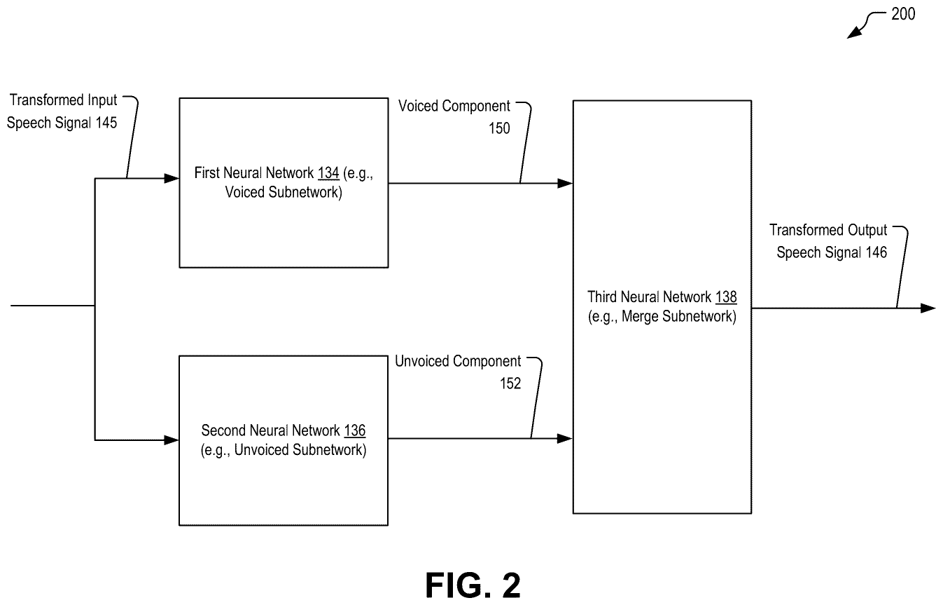

FIG. 2 is a diagram of a particular illustrative example of a system 200 that is configured to reduce echoes associated with input speech using a voiced neural network and an unvoiced neural network. The system 200 includes the first neural network 134, the second neural network 136, and the third neural network 138. According to an implementation, the neural networks 134-138 can be integrated into one or more processors.

In FIG. 2, the transformed input speech signal 145 is provided to the first neural network 134 and to the second neural network 136. The first neural network 134 is configured to perform the first decomposition operation and echo-cancellation on the transformed input speech signal 145 to generate the voiced component 150 of the transformed input speech signal 145. For example, the first neural network 134 can correspond to a voiced subnetwork that is trained to apply a voice mask (or identify transform coefficients) to isolate and extract the voiced component 150 from the transformed input speech signal 145. The voiced component 150 is provided to the third neural network 138.

The second neural network 136 is configured to perform the second decomposition operation and echo-cancellation on the transformed input speech signal 145 to generate the unvoiced component 152 of the transformed input speech signal 145. For example, the second neural network 136 can correspond to an unvoiced subnetwork that is trained to apply an unvoiced mask (or identify transform coefficients) to isolate and extract the unvoiced component 152 from the transformed input speech signal 145. The unvoiced component 152 is also provided to the third neural network 138.

The third neural network 138 is configured to merge the voiced component 150 and the unvoiced component 152 to generate a transformed output speech signal 146. The transformed output speech signal 146 can correspond to an echo-cancelled signal indicative of clean speech (e.g., a clean version of the near-end speech 112) with a reduced amount of noise and echo.

Thus, the techniques described herein improve the quality of speech decomposition and reconstruction by using multiple neural networks 134, 136 to process different components of the transformed input speech signal 145. For example, the voiced component 150 can be processed using the first neural network 134, and the unvoiced component 152 can be processed using the second neural network 136. As a result, a single neural network does not have to process different speech parts (e.g., voiced and unvoiced parts) with drastically different probability distributions, which enables improved speech quality and weight efficiency. Additionally, compared to conventional techniques (e.g., adaptive linear filtering), the techniques described herein can reduce or eliminate echo (e.g., double-talk) caused by the first microphone 106 capturing the far-end speech 114B. For example, the techniques described herein reduce the amount of echo that is transmitted using separate trained neural networks for voiced components and unvoiced components, and can cancel double-talk based on pitch differences between the speech of the users 102 and 104.

FIG. 3 is a diagram of a particular illustrative example 300 of performing a decomposition operation on stacked and transformed near-end speech and far-end speech using a convolutional u-net architecture. The example 300 of FIG. 3 includes the combining unit 133 and a neural network 301. The neural network 301 has a convolutional u-net architecture and can correspond to the first neural network 134, the second neural network 136, or both.

In FIG. 3, the transformed near-end speech signal 142 and the transformed far-end speech signal 144 are provided to the combining unit 133. The combining unit 133 can be configured to concatenate the transformed near-end speech signal 142 and the transformed far-end speech signal 144 to generate the transformed input speech signal 145. The transformed input speech signal 145 can include the frequency-domain transformed near-end speech components (based on the transformed near-end speech signal 142) stacked with the frequency-domain transformed far-end speech components (based on the transformed far-end speech signal 144). The transformed input speech signal 145 is provided to the neural network 301.

The neural network 301 includes a convolutional block 302, a convolutional bottleneck 304, and a transposed convolutional block 306. The transformed input speech signal 145 is provided to the convolutional block 302, which can include multiple sets of convolutional layers configured to perform a sequence of down-sampling operations on the transformed input speech signal 145 to generate a convolutional block output 310. As depicted in FIG. 3, information from the down-sampling (e.g., outputs of each stage of down-sampling performed by the convolutional block 302) can be provided to the transposed convolutional block 306 via a skip connection. The convolutional block output 310 is provided to the convolutional bottleneck 304. The convolutional bottleneck 304 can include one or more convolutional layers configured to generate a convolutional bottleneck output 312 based on the convolutional block output 310. The convolutional bottleneck output 312 is provided to the transposed convolutional block 306, which can include multiple sets of convolutional layers configured to perform a sequence of up-sampling operations on the convolutional bottleneck output 312, in conjunction with the information received via the skip connection (e.g., each stage of up-sampling concatenates the output of the preceding stage of up-sampling with the output from the corresponding stage of the down-sampling), to generate a component 350 based on the convolutional bottleneck output 312. The component 350 can correspond to the voiced component 150 or the unvoiced component 152.

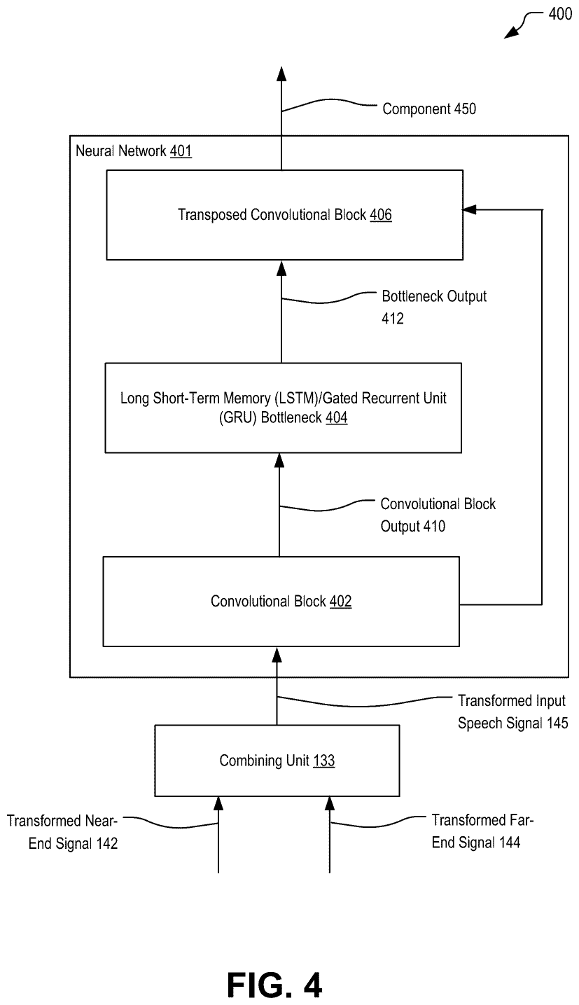

FIG. 4 a diagram of a particular illustrative example 400 of performing a decomposition operation on stacked and transformed near-end speech and far-end speech using a recurrent u-net architecture. The example 400 of FIG. 4 includes the combining unit 133 and a neural network 401. The neural network 401 has a recurrent u-net architecture and can correspond to the first neural network 134, the second neural network 136, or both.

In FIG. 4, the transformed near-end speech signal 142 and the transformed far-end speech signal 144 are provided to the combining unit 133. The combining unit 133 can be configured to concatenate the transformed near-end speech signal 142 and the transformed far-end speech signal 144 to generate the transformed input speech signal 145. The transformed input speech signal 145 can include the frequency-domain transformed near-end speech components (based on the transformed near-end speech signal 142) stacked with the frequency-domain transformed far-end speech components (based on the transformed far-end speech signal 144). The transformed input speech signal 145 is provided to the neural network 401.

The neural network 401 includes a convolutional block 402, a long short-term memory (LSTM)/gated recurrent unit (GRU) bottleneck 404, and a transposed convolutional block 406. The transformed input speech signal 145 is provided to the convolutional block 402, which can include multiple sets of convolutional layers configured to perform a sequence of down-sampling operations on the transformed input speech signal 145 to generate a convolutional block output 410. As depicted in FIG. 4, information from the down-sampling (e.g., outputs of each stage of down-sampling performed by the convolutional block 402) can be provided to the transposed convolutional block 406 via a skip connection. The convolutional block output 410 is provided to the bottleneck 404. The bottleneck 404 can include one or more convolutional layers configured to generate a bottleneck output 412 based on the convolutional block output 410. The bottleneck output 412 is provided to the transposed convolutional block 406, which can include multiple sets of convolutional layers configured to perform a sequence of up-sampling operations on the bottleneck output 412, in conjunction with the information received via the skip connection (e.g., each stage of up-sampling concatenates the output of the preceding stage of up-sampling with the output from the corresponding stage of the down-sampling), to generate a component 450 based on the bottleneck output 412. The component 450 can correspond to the voiced component 150 or the unvoiced component 152.

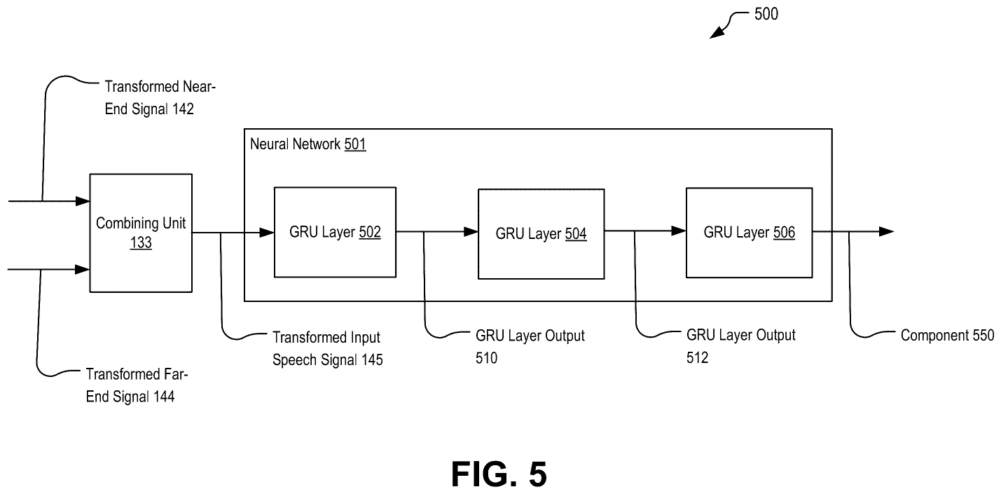

FIG. 5 is a diagram of a particular illustrative example 500 of performing a decomposition operation on stacked and transformed near-end speech and far-end speech using a recurrent layer architecture. The example 500 of FIG. 5 includes the combining unit 133 and a neural network 501. The neural network 501 has a recurrent layer architecture and can correspond to the first neural network 134, the second neural network 136, or both.

In FIG. 5, the transformed near-end speech signal 142 and the transformed far-end speech signal 144 are provided to the combining unit 133. The combining unit 133 can be configured to concatenate the transformed near-end speech signal 142 and the transformed far-end speech signal 144 to generate the transformed input speech signal 145. The transformed input speech signal 145 can include the frequency-domain transformed near-end speech components (based on the transformed near-end speech signal 142) stacked with the frequency-domain transformed far-end speech components (based on the transformed far-end speech signal 144). The transformed input speech signal 145 is provided to the neural network 501.

The neural network 501 includes three GRU layers 502, 504, 506. The transformed input speech signal 145 is provided to the GRU layer 502. The GRU layer 502 processes the transformed input speech signal 145 to generate a GRU layer output 510. The GRU layer 504 processes the GRU layer output 510 to generate a GRU layer output 512. The GRU layer 506 processes the GRU layer output 512 to generate a component 550 that can correspond to the voiced component 150 or the unvoiced component 152. To illustrate, the GRU layers 502, 504, and 506 can be trained to produce speech masks or speech directly (in some transformed domain, which may be learned or pre-defined).

Although the recurrent layer architecture of the neural network 501 is illustrated as including three GRU layers, in other implementations the neural network 501 can include stacked recurrent neural network (RNN) layers, LSTM layers, GRU layers, or any combination thereof. Although three recurrent layers are illustrated, in other implementations, any number of recurrent layers can be used.

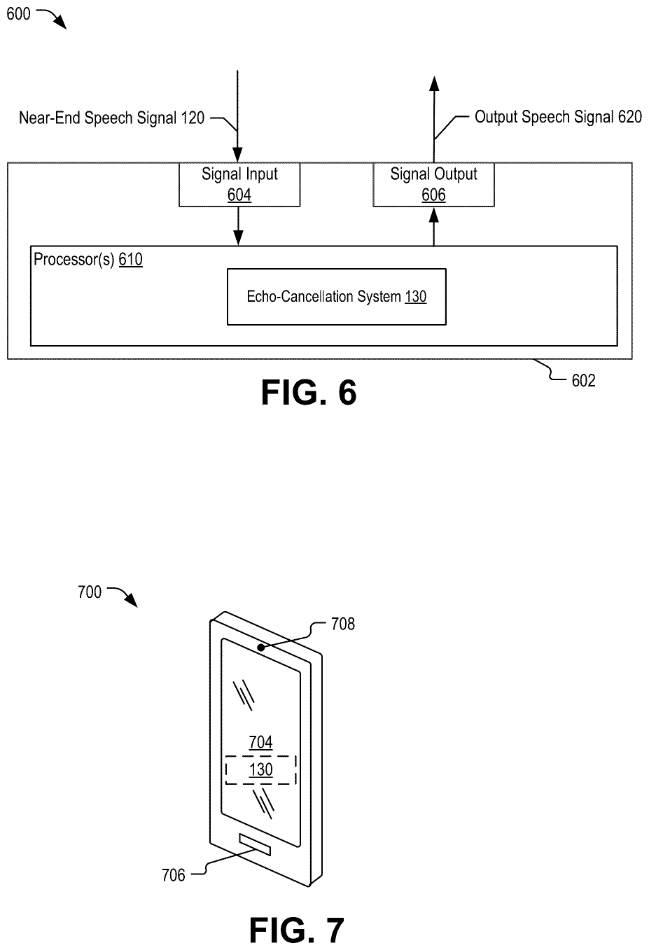

FIG. 6 is a block diagram illustrating an implementation 600 of an integrated circuit 602 that is configured to reduce echoes associated with input speech using a voiced neural network and an unvoiced neural network. The integrated circuit 602 includes one or more processors 610, which includes the echo-cancellation system 130. The integrated circuit 602 also includes a signal input 604, such as a bus interface, to enable the near-end speech signal 120 to be received. The integrated circuit 602 includes a signal output 606, such as a bus interface, to enable outputting an output speech signal 620. The output speech signal 620 can correspond to a time-domain version of the transformed output speech signal 146. For example, the one or more processors 610 can perform an inverse transform operation on the transformed output speech signal 146 to generate the output speech signal 620 that is provided to the signal output 606. The integrated circuit 602 enables implementation of echo cancellation for stacked and transformed near-end speech and far-end speech, such as depicted in FIG. 1.

FIG. 7 depicts an implementation 700 of a mobile device 702, such as a phone or tablet, as illustrative, non-limiting examples. The mobile device 702 includes a display screen 704, a microphone 706, and a speaker 708. To illustrate, the microphone 706 may correspond to the first microphone 106, and the speaker 708 may correspond to the speaker 110 of FIG. 1. Components of the one or more processors 610, including the echo-cancellation system 130, are integrated in the mobile device 702 and are illustrated using dashed lines to indicate internal components that are not generally visible to a user of the mobile device 702. In a particular example, the echo-cancellation system 130 operates to perform echo cancellation to reduce or remove audio played out from the speaker 708 that is captured by the microphone 706. For example, during a video or voice call with a remote participant that is using another mobile device, the echo-cancellation system 130 reduces or removes the voice of the remote participant from the audio captured by the microphone 706 so that the remote participant's voice is not transmitted back to the remote participant.

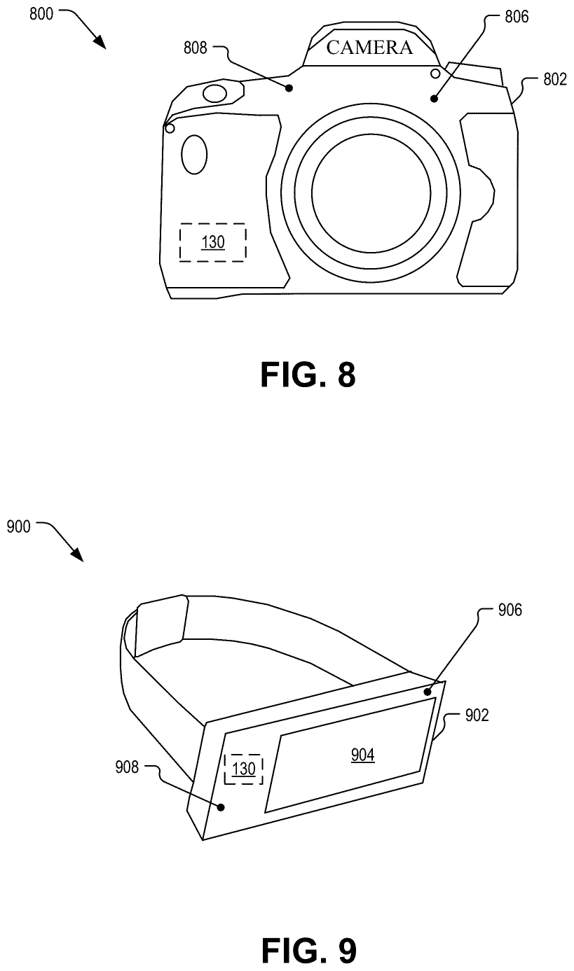

FIG. 8 depicts an implementation 800 of a portable electronic device that corresponds to a camera device 802. The camera device 802 includes a microphone 806 and a speaker 808. To illustrate, the microphone 806 may correspond to the first microphone 106, and the speaker 808 may correspond to the speaker 110 of FIG. 1. Components of the one or more processors 610, including the echo-cancellation system 130, are integrated in the camera device 802 and illustrated using dashed lines to indicate internal components that are not generally visible to a user of the camera device 802. In a particular example, the echo-cancellation system 130 operates to perform echo cancellation to reduce or remove audio played out from the speaker 808 that is captured by the microphone 806. For example, the camera device 802 can be used to capture a video recording that includes audio. In some scenarios, a user can use the microphone 806 to insert audio annotations to the video recording during playback of the video recording. The echo-cancellation system 130 reduces or removes the audio from video recording from the audio captured by the microphone 806 so that the audio annotations do not have an echo of the playback audio.

FIG. 9 depicts an implementation 900 of a wearable electronic device 902, illustrated as a “smart watch.” The wearable electronic device 902 is coupled to or includes a display screen 904 to display video data. Additionally, the wearable electronic device 902 a microphone 906, and a speaker 908. To illustrate, the microphone 906 may correspond to the first microphone 106, and the speaker 908 may correspond to the speaker 110 of FIG. 1. Components of the one or more processors 610, including the echo-cancellation system 130, are integrated in the wearable electronic device 902 and illustrated using dashed lines to indicate internal components that are not generally visible to a user of the wearable electronic device 902. In a particular example, the echo-cancellation system 130 operates to perform echo cancellation to reduce or remove audio played out from the speaker 908 that is captured by the microphone 906. For example, during a voice call with a remote participant that is using another mobile device, the echo-cancellation system 130 reduces or removes the voice of the remote participant from the audio captured by the microphone 906 so that the remote participant's voice is not transmitted back to the remote participant.

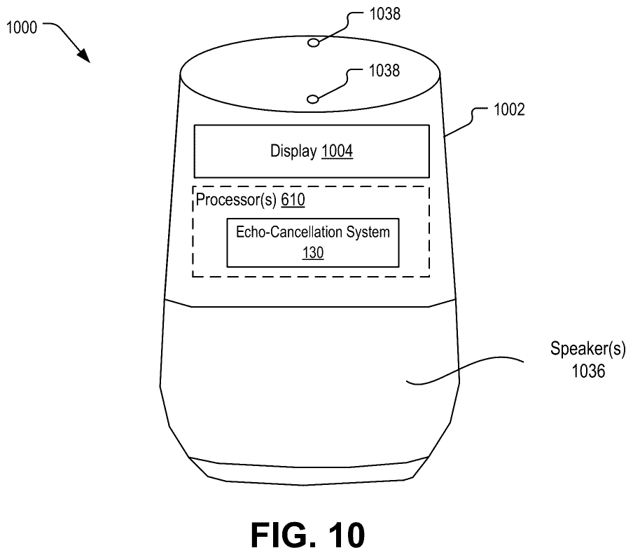

FIG. 10 is an implementation 1000 of a wireless speaker and voice activated device 1002. The wireless speaker and voice activated device 1002 can have wireless network connectivity and is configured to execute an assistant operation. The one or more processors 610 are included in the wireless speaker and voice activated device 1002 and include the echo-cancellation system 130. In a particular aspect, the wireless speaker and voice activated device 1002 includes one or more microphones 1038 and one or more speakers 1036, and also includes or is coupled to a display device 1004 for playback of video. The one or more microphones 1038 may correspond to the first microphone 106, and the one or more speakers 1036 may correspond to the speaker 110 of FIG. 1. In a particular example, the echo-cancellation system 130 operates to perform echo cancellation to reduce or remove audio played out from the one or more speakers 1036 that is captured by the one or more microphones 1038. For example, while the speakers 1036 are playing audio (e.g., music, a podcast, etc.), a user can issue a verbal command to the wireless speaker and voice activated device 1002 using the one or more microphones 1038. The echo-cancellation system 130 reduces or removes the audio output by the speakers 1036 from the audio captured by the microphone 1038 to improve speech recognition of the verbal command. In response to the a verbal command, the wireless speaker and voice activated device 1002 can execute assistant operations, such as via execution of a voice activation system (e.g., an integrated assistant application). The assistant operations can include adjusting a temperature, playing media content such as stored or streaming audio and video content, turning on lights, etc. For example, the assistant operations are performed responsive to receiving a command after a keyword or key phrase (e.g., “hello assistant”).

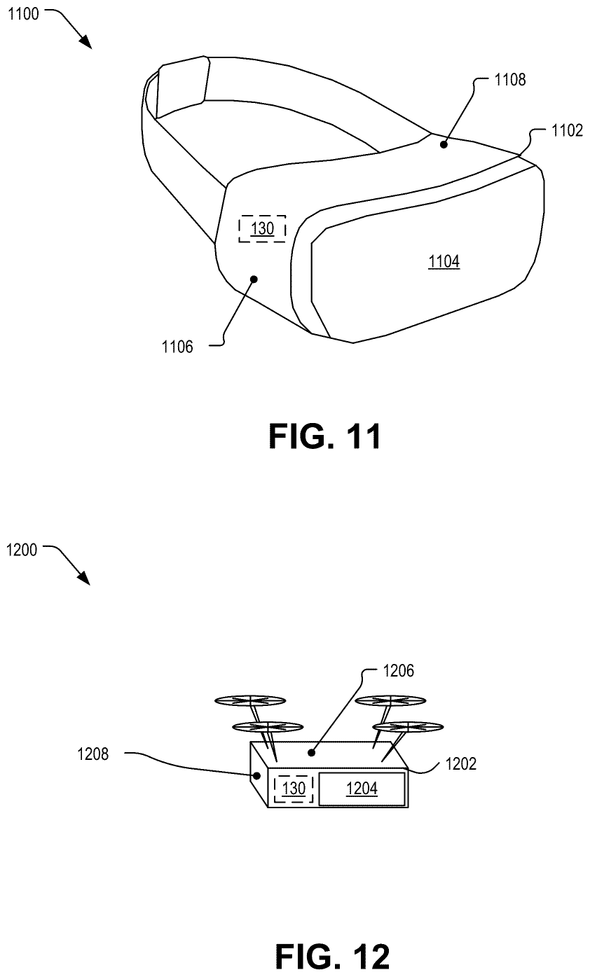

FIG. 11 depicts an implementation 1100 of a portable electronic device that corresponds to a virtual reality, augmented reality, or mixed reality headset 1102. A visual interface device 1104 is positioned in front of the user's eyes to enable display of video associated with augmented reality, mixed reality, or virtual reality scenes to the user while the headset 1102 is worn. The headset 1102 includes a microphone 1106 and a speaker 1108. To illustrate, the microphone 1106 may correspond to the first microphone 106, and the speaker 1108 may correspond to the speaker 110 of FIG. 1. Components of the one or more processors 610, including the echo-cancellation system 130, are integrated in the headset 1102. In a particular example, the echo-cancellation system 130 operates to perform echo cancellation to reduce or remove audio played out from the speaker 1108 that is captured by the microphone 1106. For example, if the user is using the headset 1102 to experience an immersive multi-participant open-world virtual reality (VR) scenario, the speaker 1108 can output audio from other participants of the VR scenario. The echo-cancellation system 130 operates to perform echo cancellation to reduce or remove audio played out from the speaker 1108 that is captured by the microphone 1106. For example, the echo-cancellation system 130 reduces or removes the voice of the other participants from the audio captured by the microphone 1106 so that the other participants' voices are not transmitted back to them via double-talk during conversations.

FIG. 12 depicts an implementation 1200 in which the echo-cancellation system 130 corresponds to or is integrated within a vehicle 1202, illustrated as a manned or unmanned aerial device (e.g., a package delivery drone). The vehicle 1202 includes a display device 1204, a microphone 1206 and a speaker 1208. To illustrate, the microphone 1206 may correspond to the first microphone 106, and the speaker 1208 may correspond to the speaker 110 of FIG. 1. In some implementations, the vehicle 1202 is manned (e.g., carries a pilot, one or more passengers, or both) and the display device 1204 is internal to a cabin of the vehicle 1202. Components of the one or more processors 610, including the echo-cancellation system 130, are integrated in the vehicle 1202. In a particular example, the echo-cancellation system 130 operates to perform echo cancellation to reduce or remove audio played out from the speaker 1208 that is captured by the microphone 1206. For example, a during a communication with a flight controller, the echo-cancellation system 130 reduces or removes the voice of the flight controller from the audio captured by the microphone 1206 so that the flight controller's voice is not transmitted back to the flight controller.

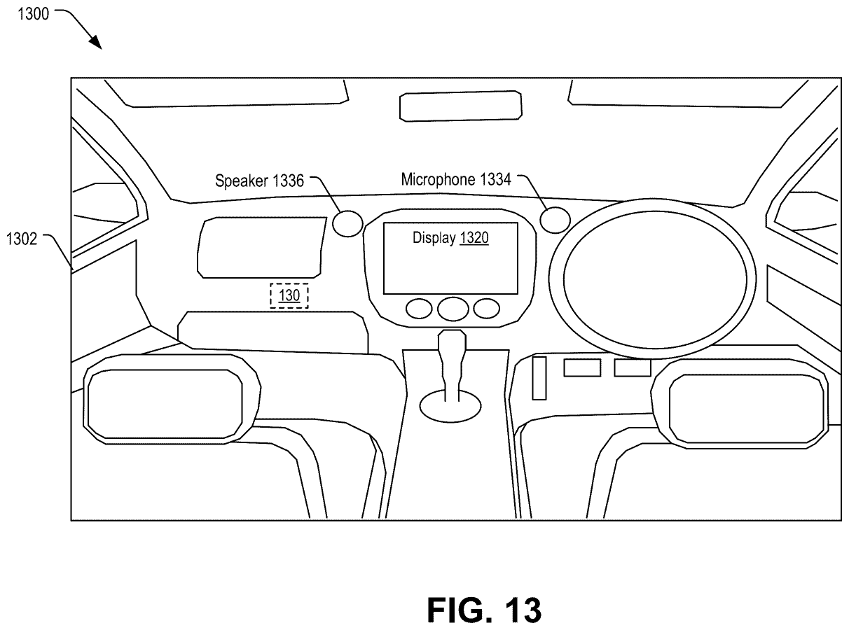

FIG. 13 depicts an implementation 1300 of a vehicle 1302, illustrated as a car that includes the echo-cancellation system 130, a display device 1320, a microphone 1334, and speakers 1336. The microphone 1334 may correspond to the first microphone 106, and the speakers 1336 may correspond to the speaker 110 of FIG. 1. Components of the one or more processors 610, including the echo-cancellation system 130, are integrated in the vehicle 1302. In a particular example, the echo-cancellation system 130 operates to perform echo cancellation to reduce or remove audio played out from the speakers 1336 that is captured by the microphone 1334. For example, during a voice call with a remote participant, the echo-cancellation system 130 reduces or removes the voice of the remote participant from the audio captured by the microphone 1334 so that the remote participant's voice is not transmitted back to the remote participant.

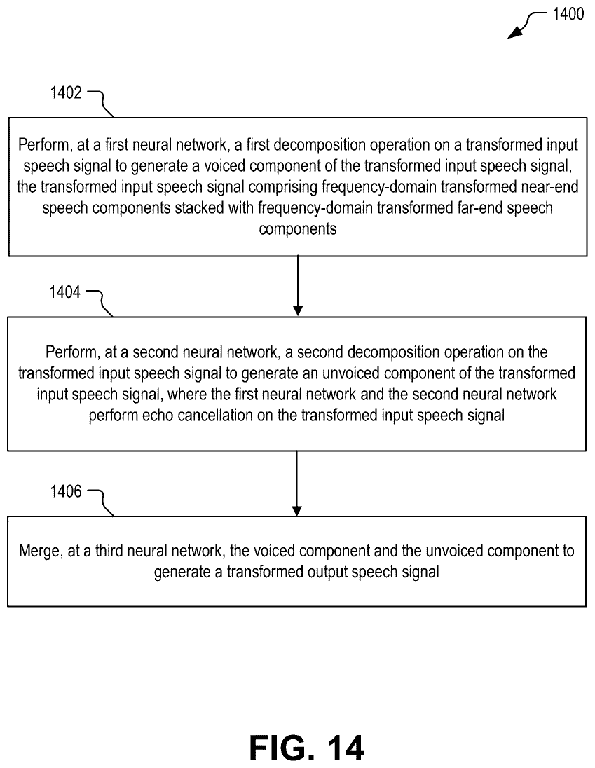

FIG. 14 is a flowchart of a particular example of a method 1400 of reducing echoes associated with input speech using a voiced neural network and an unvoiced neural network. In various implementations, the method 1400 may be performed by one or more of the echo-cancellation system 130 of FIG. 1, the system 100 of FIG. 1, the system 200 of FIG. 2, one or more components of the example 300 of FIG. 3, one or more components of the example 400 of FIG. 4, one or more components of the example 500 of FIG. 5, the integrated circuit 602 of FIG. 6, or any of the devices of FIGS. 7-13.

The method 1400 includes performing, at a first neural network, a first decomposition operation on a transformed input speech signal to generate a voiced component of the transformed input speech signal, at block 1402. The transformed input speech signal includes frequency-domain transformed near-end speech components stacked with frequency-domain transformed far-end speech components. For example, referring to FIG. 1, the first neural network 134 performs the first decomposition operation on the transformed input speech signal 145 to generate the voiced component 150 of the transformed input speech signal 145. According to some implementations of the method 1400, the first neural network 134 applies a voiced mask to isolate and extract the voiced component 150 from the transformed input speech signal 145. The transformed input speech signal 145 can include frequency-domain near-end speech components (based on the transformed near-end speech signal 142) stacked with frequency-domain transformed far-end speech components (based on the transformed far-end speech signal 144).

The method 1400 also includes performing, at a second neural network, a second decomposition operation on the transformed input speech signal to generate an unvoiced component of the transformed input speech signal, at block 1404. The first neural network and the second neural network perform echo cancellation on the transformed input speech signal. For example, referring to FIG. 1, the second neural network 136 performs the second decomposition operation on the transformed input speech signal 145 to generate the unvoiced component 152 of the transformed input speech signal 145. According to some implementations of the method 1400, the second neural network 136 applies an unvoiced mask to isolate and extract the unvoiced component 152 from the transformed input speech signal 145.

The method 1400 also includes merging, at a third neural network, the voiced component and the unvoiced component to generate a transformed output speech signal, at block 1406. For example, referring to FIG. 1, the third neural network 138 merges the voiced component 150 and the unvoiced component 152 to generate the transformed output speech signal 146.

According to some implementations, the method 1400 can include performing a first transform operation on a near-end speech signal to generate a transformed near-end speech signal. For example, referring to FIG. 1, the transform unit 132A can perform the transform operation on the near-end speech signal 120 to generate the transformed near-end speech signal 142. According to some implementations, the method 1400 can include performing a second transform operation on a far-end speech signal to generate a transformed far-end speech signal. For example, referring to FIG. 1, the transform unit 132B can perform the transform operation on the far-end speech signal 116 to generate the transformed far-end speech signal 144. According to some implementations, the method 1400 can also include concatenating the transformed near-end speech signal and the transformed far-end speech signal to generate the transformed input speech signal. For example, referring to FIG. 1, the combining unit 133 can concatenate the transformed near-end speech signal 142 and the transformed far-end speech signal 144 to generate the transformed input speech signal 145.

The method 1400 improves the quality of speech decomposition and reconstruction by using multiple neural networks 134, 136 to process different components of the transformed input speech signal 145. For example, the voiced component 150 can be processed using the first neural network 134, and the unvoiced component 152 can be processed using the second neural network 136. As a result, a single neural network does not have to process different speech parts (e.g., voiced and unvoiced parts) with drastically different probability distributions. Additionally, compared to conventional techniques (e.g., adaptive linear filtering), the method 1400 can reduce or eliminate echo (e.g., double-talk) caused by the first microphone 106 capturing the far-end speech 114B. For example, the techniques described herein reduce the amount of echo that is transmitted using separate trained neural networks for voiced components and unvoiced components, and can cancel double-talk based on pitch differences between the speech of the users 102 and 104.

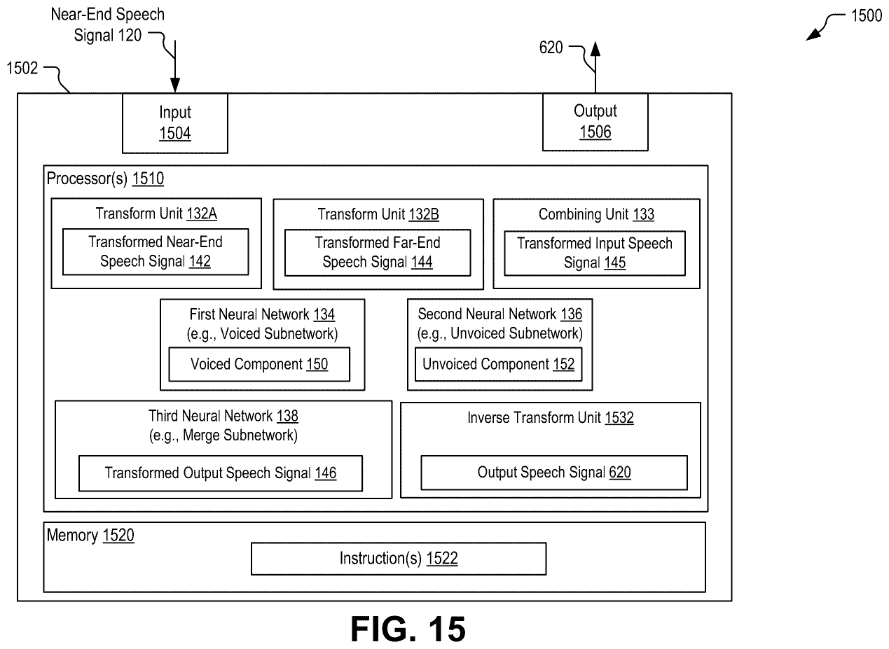

The method 1400 of FIG. 14 may be implemented by a FPGA device, an ASIC, a processing unit such as a CPU, a DSP, a GPU, a controller, another hardware device, firmware device, or any combination thereof. As an example, the method 1400 of FIG. 14 may be performed by a processor that executes instructions, such as described with reference to processor(s) 1510 of FIG. 15.

FIG. 15 depicts an implementation 1500 in which a device 1502 includes one or more processors 1510 that include components of the echo-cancellation system 130. For example, the one or more processors 1510 include the transform unit 132A, the transform unit 132B, the combining unit 133, the first neural network 134, the second neural network 136, and the third neural network 138. The one or more processors 1510 also include an inverse transform unit 1532 that is configured to perform an inverse transform operation (e.g., an Inverse Fast Fourier Transform (IFFT) operation, an Inverse Discrete Cosine Transform (IDCT) operation, etc.) on the transformed output speech signal 146 to generate the output speech signal 620. The device 1502 also includes an input interface 1504 (e.g., one or more bus or wireless interfaces) configured to an receive input signal, such as the near-end speech signal 120, and an output interface 1506 (e.g., one or more bus or wireless interfaces) configured to output a signal, such as the output speech signal 620. The device 1502 may correspond to a system-on-chip or other modular device that can be integrated into other systems to provide data encoding, such as within a mobile phone, another communication device, an entertainment system, or a vehicle, as illustrative, non-limiting examples. According to some implementations, the device 1502 may be integrated into a server, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a headset, an augmented reality headset, a mixed reality headset, a virtual reality headset, a motor vehicle such as a car, or any combination thereof.

In the illustrated implementation 1500, the device 1502 includes a memory 1520 (e.g., one or more memory devices) that includes instructions 1522, and the one or more processors 1510 are coupled to the memory 1520 and configured to execute the instructions 1522 from the memory 1520. For example, executing the instructions 1522 causes the one or more processors 1510 (e.g., the transform unit 132A) to perform the first transform operation on the near-end speech signal 120 to generate the transformed near-end speech signal 142. Executing the instructions 1522 also causes the one or more processors 1510 (e.g., the transform unit 132B) to perform the second transform operation on the far-end speech signal 116 to generate the transformed far-end speech signal 144. Executing the instructions 1522 can also cause the one or more processors 1510 (e.g., the combining unit 133) to concatenate the transformed near-end speech signal 142 and the transformed far-end speech signal 144 to generate the transformed input speech signal 145. As described above, the first neural network 134 can generate the voiced component 150, the second neural network 136 can generate the unvoiced component 152, and the third neural network 138 can merge the voiced component 150 and the unvoiced component 152 to generate the transformed output speech signal 146. The inverse transform unit 1532 can be configured to perform an inverse transform operation (e.g., an Inverse Fast Fourier Transform (IFFT) operation, an Inverse Discrete Cosine Transform (IDCT) operation, etc.) on the transformed output speech signal to generate the output speech signal 620.

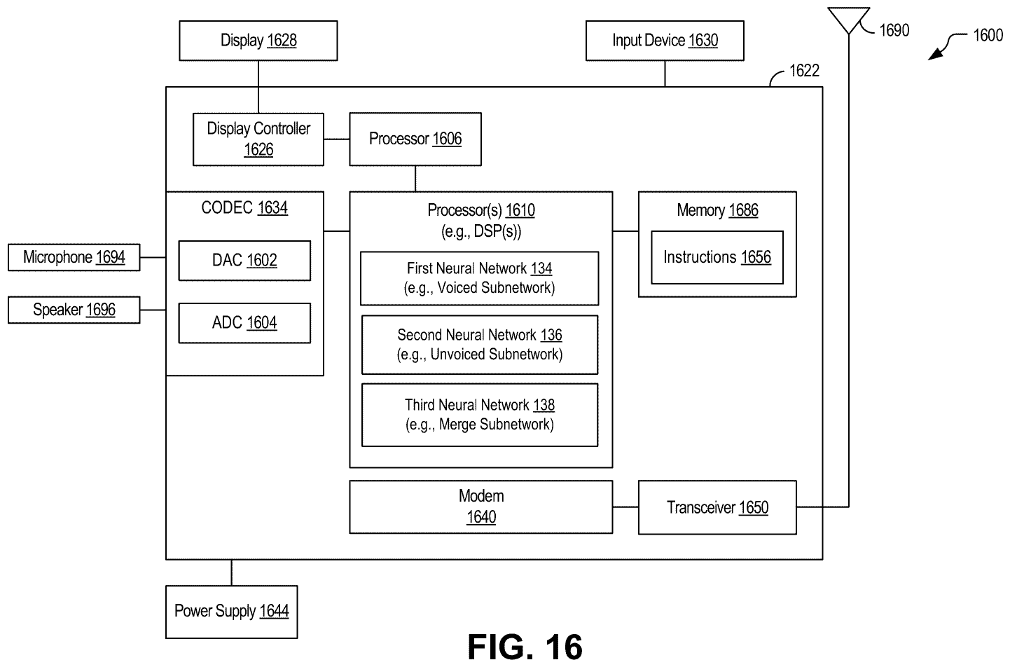

Referring to FIG. 16, a block diagram of a particular illustrative implementation of a device is depicted and generally designated 1600. In various implementations, the device 1600 may have more or fewer components than illustrated in FIG. 16. In an illustrative implementation, the device 1600 may perform one or more operations described with reference to FIGS. 1-15.

In a particular implementation, the device 1600 includes a processor 1606 (e.g., a CPU). The device 1600 may include one or more additional processors 1610 (e.g., one or more DSPs, one or more GPUs, or a combination thereof). The processor(s) 1610 includes components of the echo-cancellation system 130, such as the first neural network 134, the second neural network 136, and the third neural network 138. In some implementations, the processor(s) 1610 includes additional components, such as the transform unit 132A, the transform unit 132B, the combining unit 133, the inverse transform unit 1532, etc. According to some implementations, the processor(s) 1610 includes a speech and music coder-decoder (CODEC) (not shown). In these implementations, components of the echo-cancellation system 130 can be integrated into the speech and music CODEC.

The device 1600 also includes a memory 1686 and a CODEC 1634. The memory 1686 may include instructions 1656 that are executable by the one or more additional processors 1610 (or the processor 1606) to implement the functionality described herein. The device 1600 may include a modem 1640 coupled, via a transceiver 1650, to an antenna 1690.

The device 1600 may include a display 1628 coupled to a display controller 1626. A speaker 1696 and a microphone 1694 may be coupled to the CODEC 1634. According to an implementation, the speaker 1696 corresponds to the speaker 110 of FIG. 1. According to an implementation, the microphone 1694 corresponds to the first microphone 106 of FIG. 1. The CODEC 1634 may include a digital-to-analog converter (DAC) 1602 and an analog-to-digital converter (ADC) 1604. In a particular implementation, the CODEC 1634 may receive an analog signal from the microphone 1694, convert the analog signal to a digital signal using the analog-to-digital converter 1604, and provide the digital signal to the processor(s) 1610. The processor(s) 1610 may process the digital signals. In a particular implementation, the processor(s) 1610 may provide digital signals to the CODEC 1634. The CODEC 1634 may convert the digital signals to analog signals using the digital-to-analog converter 1602 and may provide the analog signals to the speaker 1696.

In a particular implementation, the device 1600 may be included in a system-in-package or system-on-chip device 1622. In a particular implementation, the memory 1686, the processor 1606, the processors 1610, the display controller 1626, the CODEC 1634, and the modem 1640 are included in the system-in-package or system-on-chip device 1622. In a particular implementation, an input device 1630 and a power supply 1644 are coupled to the system-in-package or system-on-chip device 1622. Moreover, in a particular implementation, as illustrated in FIG. 16, the display 1628, the input device 1630, the speaker 1696, the microphone 1694, the antenna 1690, and the power supply 1644 are external to the system-in-package or system-on-chip device 1622. In a particular implementation, each of the display 1628, the input device 1630, the speaker 1696, the microphone 1694, the antenna 1690, and the power supply 1644 may be coupled to a component of the system-in-package or system-on-chip device 1622, such as an interface or a controller. In some implementations, the device 1600 includes additional memory that is external to the system-in-package or system-on-chip device 1622 and coupled to the system-in-package or system-on-chip device 1622 via an interface or controller.

The device 1600 may include a smart speaker (e.g., the processor 1606 may execute the instructions 1656 to run a voice-controlled digital assistant application), a speaker bar, a mobile communication device, a smart phone, a cellular phone, a laptop computer, a computer, a tablet, a personal digital assistant, a display device, a television, a gaming console, a music player, a radio, a digital video player, a DVD player, a tuner, a camera, a navigation device, a headset, an augmented realty headset, a mixed reality headset, a virtual reality headset, a vehicle, or any combination thereof.

In conjunction with the described implementations, an apparatus includes means for performing a first decomposition operation on a transformed input speech signal to generate a voiced component of the transformed input speech signal. The transformed input speech signal includes frequency-domain transformed near-end speech components stacked with frequency-domain transformed far-end speech components. The means for performing the first decomposition operation includes the first neural network 134, the echo-cancellation system 130, the processor(s) 610, the processor(s) 1510, the processor(s) 1610, one or more other circuits or components configured to perform the first decomposition operation, or any combination thereof.

The apparatus also includes means for performing a second decomposition operation on the transformed input speech signal to generate an unvoiced component of the transformed input speech signal. The means for performing the first decomposition operation and the means for performing the second decomposition operation perform echo cancellation on the transformed input speech signal. The means for performing the second decomposition operation includes the second neural network 136, the echo-cancellation system 130, the processor(s) 610, the processor(s) 1510, the processor(s) 1610, one or more other circuits or components configured to perform the second decomposition operation, or any combination thereof.

The apparatus further includes means for merging the voice component and the unvoiced component to generate a transformed output speech signal. For example, the means for merging includes the third neural network 138, the echo-cancellation system 130, the processor(s) 610, the processor(s) 1510, the processor(s) 1610, one or more other circuits or components configured to merge the voice component and the unvoiced component, or any combination thereof.

In some implementations, a non-transitory computer-readable medium includes instructions that, when executed by one or more processors, cause the one or more processors to perform, at a first neural network (e.g., the first neural network 134), a first decomposition operation on a transformed input speech signal (e.g., the transformed input speech signal 145) to generate a voiced component (e.g., the voiced component 150) of the transformed input speech signal. The transformed input speech signal includes frequency-domain transformed near-end speech components stacked with frequency-domain transformed far-end speech components. Execution of the instructions also causes the one or more processors to perform, at a second neural network (e.g., the second neural network 136), a second decomposition operation on the transformed input speech signal to generate an unvoiced component (e.g., the unvoiced component 152) of the transformed input speech signal. The first neural network and the second neural network perform echo cancellation on the transformed input speech signal. Execution of the instructions further causes the one or more processors to merge, at a third neural network (e.g. the third neural network 138), the voiced component and the unvoiced component to generate a transformed output speech signal (e.g., the transformed output speech signal 146).

Particular aspects of the disclosure are described below in sets of interrelated examples:

### Example 1

A device comprising: a first neural network configured to perform a first decomposition operation on a transformed input speech signal to generate a voiced component of the transformed input speech signal, the transformed input speech signal comprising frequency-domain transformed near-end speech components stacked with frequency-domain transformed far-end speech components; a second neural network configured to perform a second decomposition operation on the transformed input speech signal to generate an unvoiced component of the transformed input speech signal, wherein the first neural network and the second neural network perform echo cancellation on the transformed input speech signal; and a third neural network configured to merge the voiced component and the unvoiced component to generate a transformed output speech signal.

### Example 2

The device of Example 1, wherein the first neural network has one of a recurrent layer architecture, a convolutional u-net architecture, or a recurrent u-net architecture.

### Example 3

The device of Example 1 or 2, wherein the second neural network has one of a recurrent layer architecture, a convolutional u-net architecture, or a recurrent u-net architecture.

### Example 4

The device of any of Examples 1 to 3, wherein the first neural network and the second neural network perform noise reduction on the transformed input speech signal.

### Example 5

The device of any of Examples 1 to 4, further comprising: a first transform unit configured to perform a first transform operation on a near-end speech signal to generate a transformed near-end speech signal; a second transform unit configured to perform a second transform operation on a far-end speech signal to generate a transformed far-end speech signal; and a combining unit configured to concatenate the transformed near-end speech signal and the transformed far-end speech signal to generate the transformed input speech signal.

### Example 6

The device of any of Examples 1 to 5, further comprising a microphone configured to capture near-end speech to generate the near-end speech signal.

### Example 7

The device of Example 6, further comprising a speaker configured to output far-end speech associated with the far-end speech signal, wherein the speaker is proximate to the microphone.

### Example 8

The device of any of Examples 1 to 7, wherein the first neural network, the second neural network, and the third neural network are integrated into a mobile device.

### Example 9

The device of any of Examples 1 to 8, wherein the first neural network is configured to apply a voiced mask to isolate and extract the voiced component from the transformed input speech signal.

### Example 10

The device of any of Examples 1 to 9, wherein the second neural network is configured to apply an unvoiced mask to isolate and extract the unvoiced component from the transformed input speech signal.

### Example 11

A method comprising: performing, at a first neural network, a first decomposition operation on a transformed input speech signal to generate a voiced component of the transformed input speech signal, the transformed input speech signal comprising frequency-domain transformed near-end speech components stacked with frequency-domain transformed far-end speech components; performing, at a second neural network, a second decomposition operation on the transformed input speech signal to generate an unvoiced component of the transformed input speech signal, wherein the first neural network and the second neural network perform echo cancellation on the transformed input speech signal; and merging, at a third neural network, the voiced component and the unvoiced component to generate a transformed output speech signal.

### Example 12

The method of Example 11, wherein the first neural network has one of a recurrent layer architecture, a convolutional u-net architecture, or a recurrent u-net architecture.

### Example 13

The method of Example 11 or 12, wherein the second neural network has one of a recurrent layer architecture, a convolutional u-net architecture, or a recurrent u-net architecture.

### Example 14

The method of any of Examples 11 to 13, wherein the first neural network and the second neural network perform noise reduction on the transformed input speech signal.

### Example 15

The method of any of Examples 11 to 14, further comprising: performing a first transform operation on a near-end speech signal to generate a transformed near-end speech signal; performing a second transform operation on a far-end speech signal to generate a transformed far-end speech signal; and concatenating the transformed near-end speech signal and the transformed far-end speech signal to generate the transformed input speech signal.

### Example 16

The method of Example 15, further comprising capturing near-end speech to generate the near-end speech signal.

### Example 17

The method of any of Examples 11 to 16, wherein the first neural network is configured to apply a voiced mask to isolate and extract the voiced component from the transformed input speech signal.

### Example 18

The method of any of Examples 11 to 17, wherein the second neural network is configured to apply an unvoiced mask to isolate and extract the unvoiced component from the transformed input speech signal.

### Example 19

A non-transitory computer-readable comprising instructions that, when executed by one or more processors, cause the one or more processors to: perform, at a first neural network, a first decomposition operation on a transformed input speech signal to generate a voiced component of the transformed input speech signal, the transformed input speech signal comprising frequency-domain transformed near-end speech components stacked with frequency-domain transformed far-end speech components; perform, at a second neural network, a second decomposition operation on the transformed input speech signal to generate an unvoiced component of the transformed input speech signal, wherein the first neural network and the second neural network perform echo cancellation on the transformed input speech signal; and merge, at a third neural network, the voiced component and the unvoiced component to generate a transformed output speech signal.

### Example 20

The non-transitory computer-readable medium of Example 19, wherein the first neural network has one of a recurrent layer architecture, a convolutional u-net architecture, or a recurrent u-net architecture.

### Example 21

The non-transitory computer-readable medium of Example 19 or 20, wherein the second neural network has one of a recurrent layer architecture, a convolutional u-net architecture, or a recurrent u-net architecture.

### Example 22

The non-transitory computer-readable medium of any of Examples 19 to 21, wherein the first neural network and the second neural network perform noise reduction on the transformed input speech signal.

### Example 23

The non-transitory computer-readable medium of any of Examples 19 to 22, wherein the instructions, when executed by the one or more processors, further cause the one or more processors to: perform a first transform operation on a near-end speech signal to generate a transformed near-end speech signal; perform a second transform operation on a far-end speech signal to generate a transformed far-end speech signal; and concatenate the transformed near-end speech signal and the transformed far-end speech signal to generate the transformed input speech signal.

### Example 24

The non-transitory computer-readable medium of any of Examples 19 to 23, wherein the first neural network applies a voiced mask to isolate and extract the voiced component from the transformed input speech signal.

### Example 25

The non-transitory computer-readable medium of any of Examples 19 to 24, wherein the second neural network applies an unvoiced mask to isolate and extract the unvoiced component from the transformed input speech signal.

### Example 26

An apparatus comprising: means for performing a first decomposition operation on a transformed input speech signal to generate a voiced component of the transformed input speech signal, the transformed input speech signal comprising frequency-domain transformed near-end speech components stacked with frequency-domain transformed far-end speech components; means for performing a second decomposition operation on the transformed input speech signal to generate an unvoiced component of the transformed input speech signal, wherein the means for performing the first decomposition operation and the means for performing the second decomposition operation perform echo cancellation on the transformed input speech signal; and means for merging the voiced component and the unvoiced component to generate a transformed output speech signal.

### Example 27

The apparatus of Example 26, wherein the means for performing the first decomposition operation and the means for performing the second decomposition operation perform noise reduction on the transformed input speech signal.

### Example 28

The apparatus of Examples 26 or 27, further comprising: means for performing a first transform operation on a near-end speech signal to generate a transformed near-end speech signal; means for performing a second transform operation on a far-end speech signal to generate a transformed far-end speech signal; and means for concatenating the transformed near-end speech signal and the transformed far-end speech signal to generate the transformed input speech signal.

### Example 29

The apparatus of any of Examples 26 to 28, wherein the means for performing the first decomposition operation applies a voiced mask to isolate and extract the voiced component from the transformed input speech signal.

### Example 30

The apparatus of any of Examples 26 to 29, wherein the means for performing the second decomposition operation applies an unvoiced mask to isolate and extract the unvoiced component from the transformed input speech signal.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein and is to be accorded the widest scope possible consistent with the principles and novel features as defined by the following claims.

1. A device comprising:
a first neural network configured to perform a first decomposition operation on a transformed input speech signal to generate a voiced component of the transformed input speech signal, the transformed input speech signal comprising frequency-domain transformed near-end speech components stacked with frequency-domain transformed far-end speech components;
a second neural network configured to perform a second decomposition operation on the transformed input speech signal to generate an unvoiced component of the transformed input speech signal, wherein the first neural network and the second neural network perform echo cancellation on the transformed input speech signal; and
a third neural network configured to merge the voiced component and the unvoiced component to generate a transformed output speech signal.

2. The device of claim 1, wherein the first neural network has one of a recurrent layer architecture, a convolutional u-net architecture, or a recurrent u-net architecture.

3. The device of claim 1, wherein the second neural network has one of a recurrent layer architecture, a convolutional u-net architecture, or a recurrent u-net architecture.

4. The device of claim 1, wherein the first neural network and the second neural network perform noise reduction on the transformed input speech signal.

5. The device of claim 1, further comprising:
a first transform unit configured to perform a first transform operation on a near-end speech signal to generate a transformed near-end speech signal;
a second transform unit configured to perform a second transform operation on a far-end speech signal to generate a transformed far-end speech signal; and
a combining unit configured to concatenate the transformed near-end speech signal and the transformed far-end speech signal to generate the transformed input speech signal.

6. The device of claim 5, further comprising a microphone configured to capture near-end speech to generate the near-end speech signal.

7. The device of claim 6, further comprising a speaker configured to output far-end speech associated with the far-end speech signal, wherein the speaker is proximate to the microphone.

8. The device of claim 1, wherein the first neural network, the second neural network, and the third neural network are integrated into a mobile device.

9. The device of claim 1, wherein the first neural network is configured to apply a voiced mask to isolate and extract the voiced component from the transformed input speech signal.

10. The device of claim 1, wherein the second neural network is configured to apply an unvoiced mask to isolate and extract the unvoiced component from the transformed input speech signal.

11. A method comprising:
performing, at a first neural network, a first decomposition operation on a transformed input speech signal to generate a voiced component of the transformed input speech signal, the transformed input speech signal comprising frequency-domain transformed near-end speech components stacked with frequency-domain transformed far-end speech components;
performing, at a second neural network, a second decomposition operation on the transformed input speech signal to generate an unvoiced component of the transformed input speech signal, wherein the first neural network and the second neural network perform echo cancellation on the transformed input speech signal; and
merging, at a third neural network, the voiced component and the unvoiced component to generate a transformed output speech signal.

12. The method of claim 11, wherein the first neural network has one of a recurrent layer architecture, a convolutional u-net architecture, or a recurrent u-net architecture.

13. The method of claim 11, wherein the second neural network has one of a recurrent layer architecture, a convolutional u-net architecture, or a recurrent u-net architecture.

14. The method of claim 11, wherein the first neural network and the second neural network perform noise reduction on the transformed input speech signal.

15. The method of claim 11, further comprising:
performing a first transform operation on a near-end speech signal to generate a transformed near-end speech signal;
performing a second transform operation on a far-end speech signal to generate a transformed far-end speech signal; and
concatenating the transformed near-end speech signal and the transformed far-end speech signal to generate the transformed input speech signal.

16. The method of claim 15, further comprising capturing near-end speech to generate the near-end speech signal.

17. The method of claim 11, wherein the first neural network is configured to apply a voiced mask to isolate and extract the voiced component from the transformed input speech signal.

18. The method of claim 11, wherein the second neural network is configured to apply an unvoiced mask to isolate and extract the unvoiced component from the transformed input speech signal.

19. A non-transitory computer-readable medium comprising instructions that, when executed by one or more processors, cause the one or more processors to:
perform, at a first neural network, a first decomposition operation on a transformed input speech signal to generate a voiced component of the transformed input speech signal, the transformed input speech signal comprising frequency-domain transformed near-end speech components stacked with frequency-domain transformed far-end speech components;
perform, at a second neural network, a second decomposition operation on the transformed input speech signal to generate an unvoiced component of the transformed input speech signal, wherein the first neural network and the second neural network perform echo cancellation on the transformed input speech signal; and
merge, at a third neural network, the voiced component and the unvoiced component to generate a transformed output speech signal.

20-23. (canceled)

24. The non-transitory computer-readable medium of claim 19, wherein the first neural network applies a voiced mask to isolate and extract the voiced component from the transformed input speech signal, and wherein the second neural network applies an unvoiced mask to isolate and extract the unvoiced component from the transformed input speech signal.

25-30. (canceled)
